(19) United States
(12) Patent Application Publication
(10) Pub. No.: US 2005/0204005 A1
(43) Pub. Date: Sep. 15, 2005

(54) Selective treatment of messages based on junk rating

(76) Inventors: Sean E. Purcell, Seattle, WA (US); Kenneth R. Aldinger, Redmond, WA (US); Meir E. Abergel, Seattle, WA (US); Christian Fortini, Sammamish, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/799,455

(22) Filed: Mar. 12, 2004

(51) Int. Cl. G06F 15/16

(52) U.S. Cl. 709/206

(57) ABSTRACT

The present invention provides a unique system and method that mitigates viewing potentially offensive or spam-like content such as in a preview pane. In particular the system and/or method involve assigning a junk score to a message and then determining an appropriate treatment of the message based on its junk score. Messages with junk scores that exceed a challenge threshold can be hidden from a message listing such as in the user's inbox while a challenge is sent to the message sender. Upon receiving a validated and correct response from the sender, the message can be released or revealed to the user in the user's inbox. Content associated with messages with junk scores that exceed a blocking threshold can be blocked from view in a preview pane. Explicit user input can be required to unblock the content.

### TECHNICAL FIELD

This invention is related to systems and methods for identifying both legitimate (e.g., good mail) and undesired information (e.g., junk mail), and more particularly to performing selective actions on a message based in part on its junk rating.

### BACKGROUND OF THE INVENTION

The advent of global communications networks such as the Internet has presented commercial opportunities for reaching vast numbers of potential customers. Electronic messaging, and particularly electronic mail (“e-mail”), is becoming increasingly pervasive as a means for disseminating unwanted advertisements and promotions (also denoted as “spam”) to network users.

The Radicati Group, Inc., a consulting and market research firm, estimates that as of August 2002, two billion junk e-mail messages are sent each day—this number is expected to triple every two years. Individuals and entities (e.g., businesses, government agencies) are becoming increasingly inconvenienced and oftentimes offended by junk messages. As such, junk e-mail is now or soon will become a major threat to trustworthy computing.

A key technique utilized to thwart junk e-mail is employment of filtering systems/methodologies. One proven filtering technique is based upon a machine learning approach—machine learning filters assign to an incoming message a probability that the message is junk. In this approach, features typically are extracted from two classes of example messages (e.g., junk and non-junk messages), and a learning filter is applied to discriminate probabilistically between the two classes. Since many message features are related to content (e.g., words and phrases in the subject and/or body of the message), such types of filters are commonly referred to as “content-based filters”.

Some junk/spam filters are adaptive, which is important in that multilingual users and users who speak rare languages need a filter that can adapt to their specific needs. Furthermore, not all users agree on what is and is not, junk/spam. Accordingly, by employing a filter that can be trained implicitly (e.g., via observing user behavior) the respective filter can be tailored dynamically to meet a user's particular message identification needs.

One approach for filtering adaptation is to request a user(s) to label messages as junk and non-junk. Unfortunately, such manually intensive training techniques are undesirable to many users due to the complexity associated with such training let alone the amount of time required to properly effect such training. In addition, such manual training techniques are often flawed by individual users. For example, subscriptions to free mailing lists are often forgotten about by users and thus, can be incorrectly labeled as junk mail by a default filter. Since most users may not check the contents of a junk folder, legitimate mail is blocked indefinitely from the user's inbox. Another adaptive filter training approach is to employ implicit training cues. For example, if the user(s) replies to or forwards a message, the approach assumes the message to be non-junk. However, using only message cues of this sort introduces statistical biases into the training process, resulting in filters of lower respective accuracy.

Despite various training techniques, spam or junk filters are far from perfect. Messages can often be misdirected to the extent that finding a few good messages scattered throughout a junk folder can be relatively problematic. Similarly, users may mistakenly open spam messages delivered to their inbox and as a result expose them to lewd or obnoxious content. In addition, they may unknowingly “release” their e-mail address to the spammers via “web beacons”.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to a system and/or method that facilitate informing users of the content in substantially all incoming messages so as to mitigate accidental or unintentional exposure to offensive content. This can be accomplished in part by rating incoming messages according to their spam or junk characteristics and then selectively treating such messages based at least in part on their respective ratings.

Because spam filters are not 100% accurate, some messages may be misdirected to the inbox instead of to a junk-type folder. In addition, some messages can appear to be less spam-like than known junk messages but more spam-like than known good messages. In either case, the system and method provide for blocking content of a message such as an in a preview pane. Content which can be blocked includes text, images, sounds, video, URLs, embedded content, attachments, speech, and/or applets. In general, a message can be rated to determine whether the sender is known (e.g., how known the sender is in relation to the recipient—friend of a friend, etc.) and/or to determine a probability that the message is junk. If the rating exceeds a threshold, the message content that would otherwise appear in the preview pane, for example, can be blocked, blurred, or altered in some other manner causing it to be unreadable by a user. Otherwise, when a sender is found to match a trusted senders list, the message content can be shown in the preview pane. However, it should be appreciated that the user can configure the blocking setting to consider content from known senders for blocking as well.

One approach to facilitate preventing malicious or indecent content from being inadvertently viewed by a user involves the creation of a “middle state” classification or rating of a message. This middle state can indicate that a message seems to be safe for the inbox but not safe enough to preview the content (in a preview pane). As a result, the message content is blocked from being displayed in the preview pane. The message can be categorized in this middle state based at least in part on its junk score. When the junk score exceeds a threshold level, it can be classified in this middle state (e.g., a medium junk rating relative to upper and lower junk ratings) to indicate that the message content cannot be previewed.

In one aspect of the present invention, at least a portion of the content is blocked in some manner to obfuscate the content. For example, the whole message body can be blocked from view in the preview pane and in its place, a warning or notice to the user that such content has been blocked can be shown. Other visible headers as well as the subject line and From line can be altered in whole or in part as well since these fields can contain objectionable content as well.

Another aspect of the invention provides for blocking particular text or words identified as being potentially offensive to the user. In this case, a component can be trained or built with words and/or phrases that are determined to be offensive by the program author and/or that have been deemed potentially offensive by individual users. Hence, the blocking feature in the present invention can be personalized by users as desired.

Another approach to prevent the transmission of junk mail involves requiring senders of certain messages to respond to challenges. More specifically, messages which have scores exceeding a challenge-response threshold can be completely hidden from a message listing or removed from a user's inbox and stored in a temporary folder until a correct response to the challenge has been received from the message sender. If an incorrect response is received, then the message can be flagged for discard and/or moved to a trash folder. Senders who have correctly responded to challenges can be added to a designated list or database so that they are no longer subjected to challenges.

Alternatively, another aspect of the invention provides that senders can be sent challenges at a rate determined by the frequency or number of messages they send to a particular user. For example, a less frequent sender of messages to user P can be sent challenges more frequently than a more frequent sender of messages to the same user. The converse can be true as well. However, senders who appear on any type of safe list can be exempt from receiving challenges. Moreover, messages that are almost certainly junk and/or meet or exceed another threshold may not receive a challenge either as such messages can automatically be routed to a junk folder.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a message filtration and treatment system in accordance with an aspect of the present invention.

FIG. 2 is a block diagram of a message rating and treatment system in accordance with an aspect of the present invention.

FIG. 3 is a block diagram of a challenge-response system as applied to incoming messages in accordance with an aspect of the present invention.

FIG. 4 illustrates an exemplary user interface that demonstrates a blocked message in accordance with an aspect of the present invention.

FIG. 5 is a flow diagram illustrating an exemplary message filtering process in accordance with an aspect of the present invention.

FIG. 6 is a flow diagram illustrating an exemplary methodology for rating messages in accordance with an aspect of the present invention.

FIG. 7 is a flow diagram illustrating an exemplary methodology that facilitates blocking message content in at least a preview pane in accordance with an aspect of the present invention.

FIG. 8 illustrates an exemplary environment for implementing various aspects of the invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

In addition, the term “message” as employed in this application is intended to refer to e-mail messages, instant messages, conversations (e.g., by phone to computer or computer to computer), chat messages, audio messages, and/or any other type of message, such as video messages, newsgroup messages, blog messages, and/or blog comments, that can be subjected to the systems and methods described herein. The terms junk and spam are utilized interchangeably as are the terms recipient and user.

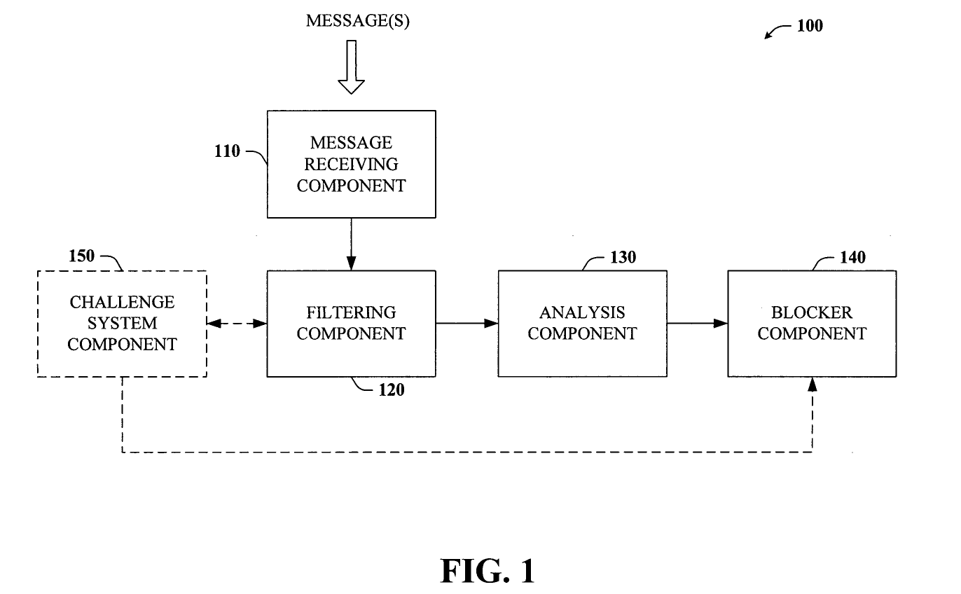

The present invention is now described with respect to FIGS. 1-8 and the corresponding discussions which follow below. It should be appreciated that for the sake of brevity and conciseness, various aspects of the invention are discussed with respect to taking actions when particular threshold levels are exceeded. However, it should be understood that such actions can be taken when threshold levels are not satisfied (e.g., a junk score or rating falls below a threshold). Therefore, both scenarios are contemplated to fall within the scope of the invention.

Referring now to FIG. 1, there is a general block diagram of a message filtration and treatment system 100 that mitigates delivery and viewing of junk messages and/or of potentially offensive content in accordance with an aspect of the present invention. The system 100 comprises a message receiving component 110 that can receive incoming messages. As messages are received, they can be sent to a filtering component 120, which can inspect messages and/or calculate junk scores. The junk score can indicate a probability or likelihood that the message is junk (e.g., spam) and can further determine a junk rating.

Once the messages are scored, they can be communicated to an analysis component 130. The analysis component can evaluate the messages and in particular, can determine whether each respective junk score exceeds or falls below, as the case may be, a first threshold. If the first threshold (e.g., junk threshold) is exceeded, for instance, then the message can be considered to be safe enough for delivery to a user's inbox but not safe enough for viewing in a preview pane. In other words, based on its junk score, the analysis component 130 can determine that the message may contain potentially offensive content and thus, can determine that its content should not be previewed in the preview pane. However, it should be appreciated that the potentially offensive content may not warrant a higher junk score that would be indicative of spam. This can be due to other data extracted from the message and evaluated by the filtering component 120 and/or analysis component 130. Messages that are otherwise “safe” as indicated by their junk scores, can be previewed as normal or as desired by the user.

Consequently, such messages designated for content blocking can be sent to a blocker component 140 which can block the message content from being viewed in the preview pane. In one approach, substantially all of the message content (e.g., message body content) can be blocked from view. Alternatively, at least words or phrases identified as being potentially offensive can be blocked or removed from the message in the preview pane.

In addition to removing the body content of the message, the blocker component 140 can blur such content so that it is no longer readable by the user in the preview pane. When the message content is blocked or removed from the preview pane, a warning or notice can be posted in its place in the preview pane to notify the user that the message content has been blocked due to potentially offensive content. The user can then employ caution when opening the message. To mitigate younger household members or others from inadvertently opening blocked messages, the invention can also require a recipient/user-specific password to open them.

Messages can be received as a whole or in parts depending on the message system. Thus, as messages are received by the message receiving component 110, information about the sender, for example, can be examined and/or compared to such lists as safe senders list as well as other safe lists created by a user, before they are scanned by a filter in the filtering component 120. When a message sender has been identified as unknown or the message itself is otherwise questionable (e.g., the filtering component 120 has assigned it a score that exceeds a second threshold such as a challenge threshold, as determined by the analysis component 130), the message listing can be hidden or removed from the user's inbox by a challenge system component 150. The challenge system component 150 can then generate and/or send at least one challenge to the sender. Upon validating that the sender's response is correct, the message can be released to the inbox. If the message is determined to exceed the junk threshold as well, then the content of the message can be blocked in the manner described above.

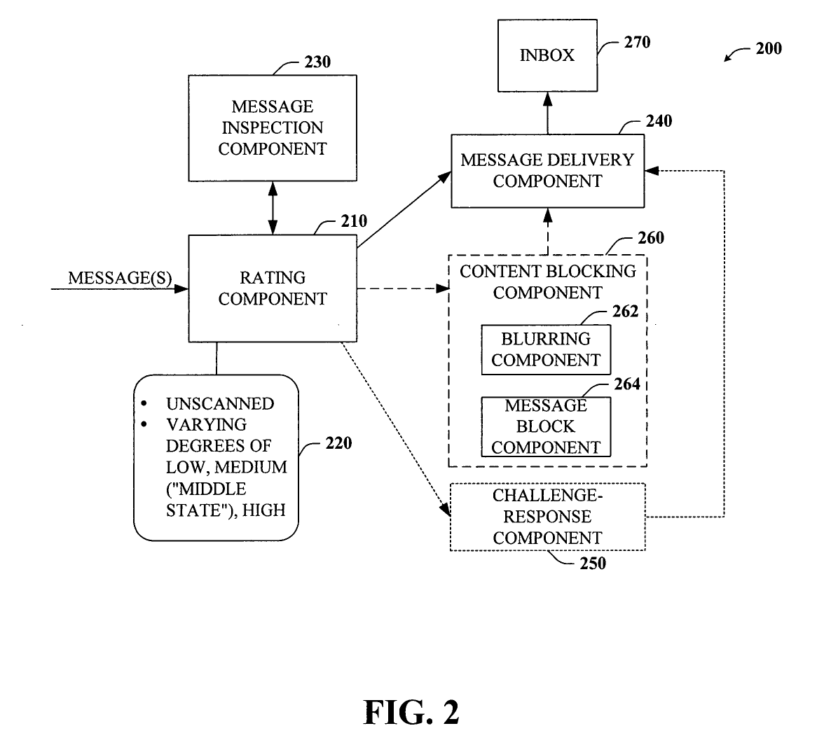

Referring now to FIG. 2, there is described a system 200 that provides special treatment of certain messages based at least in part on their junk rating in accordance with an aspect of the present invention. The system 200 comprises a rating component 210 that can accept and rate incoming messages. The rating component 210 can assign one or more ratings 220 to a message depending on several factors including the message sender and/or the message content. For example, the message can be given an “unscanned” rating upon its receipt before it has been subjected to any type of analysis or inspection by a message inspection component 230. After the message has been appropriately scanned and/or examined by the message inspection component 230, the unscanned rating can be updated as necessary. For instance, other types of ratings include or correspond to varying degrees of high and low ratings and a middle state which can refer to a medium rating. The medium rating can include any number of ratings that fall between the high and low ratings.

Depending on the rating, the message can be sent directly to any one of a message delivery component 240, a challenge-response component 250, or a content-blocking component 260. For example, a low-rated message indicates that it is probably not junk or spam and thus can be delivered to the user's inbox 270 by way of the message delivery component 240. A high rated message can indicate that the message has a higher probability of being junk or spam. This message can be sent to the challenge response system 250 which triggers a challenge to be sent to the sender or the sender's computer from, for example, the message recipient's server. The challenge can be in the form of an easily solvable question or puzzle. The sender's response can be received by the challenge response component and validated for its accuracy. Upon validation, the message can be released to the recipient's inbox via the message delivery component 240. In addition, challenged messages can also be subjected to content blocking if their respective junk ratings or scores are sufficient to trigger the content blocking component 260. Though not depicted in the figure, messages given a very high rating or any other rating that indicates a near certainty that the message is spam or junk can be directed to a discard folder automatically.

In addition to the varying degrees of high and low rated messages, messages can also be given a medium rating which indicates that the message is in a middle state. This middle state means that the message appears to be safe for delivery to the inbox 270 but not quite safe enough to be previewed such as in a preview pane of the inbox 270. Messages placed in this middle state can be sent to the content blocking component 260 where the content or at least a portion thereof can be blurred by a blurring component 262 or blocked from view by a message blocking component 264. Such blocked messages can be visible in the user's inbox 270 (via the message delivery component 240); however the content in the message body may be either removed or blurred in some way to make it unreadable in the preview pane.

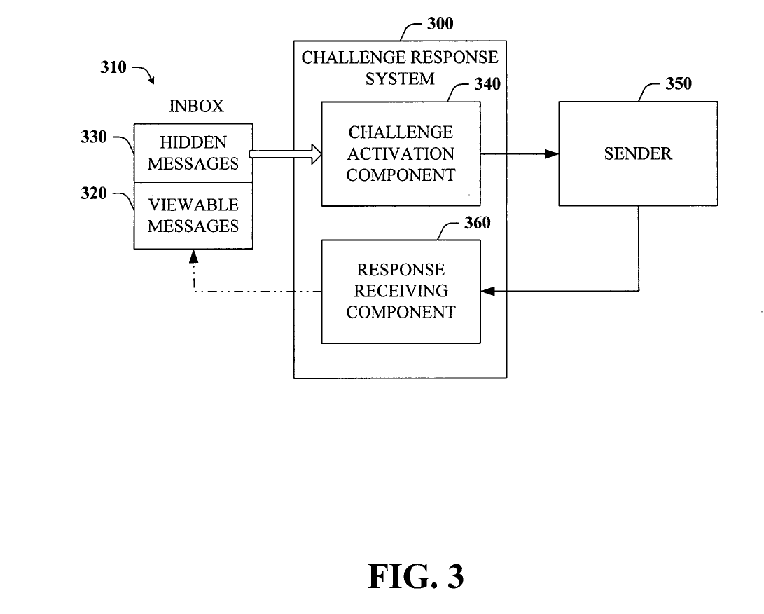

Turning to FIG. 3, there is illustrated a challenge-response system 300 interfacing with a user's inbox 310 in accordance with an aspect of the present invention. As can be seen, the inbox 310 can include viewable messages 320 as well as hidden messages 330 which are physically present in the inbox 310 but hidden from the user's view (e.g., message listing is not displayed). Messages can be hidden upon receipt when they are determined to be somewhat questionable for a variety of reasons. They can be allowed to pass through to the user's inbox; however they remain out of view so that the user cannot see that they are present. Messages can be considered questionable when the sender is unknown and other information regarding the message may indicate that the message is more spam-like.

When the challenge response system 300 is triggered, a challenge activation component 350 can send a challenge message to the sender 360 of the questionable message. The challenge message can include a URL, for example, which when clicked by the sender, directs the sender to a webpage. The webpage can include a puzzle or question that is easily and readily solvable by humans. The sender submits his response to the puzzle or question to a response receiving component 370 also located in the challenge response system 300. The sender's response can then be validated for its accuracy. If the response is correct, the message can be released, unblocked, or “un-hidden” in the user's inbox 310.

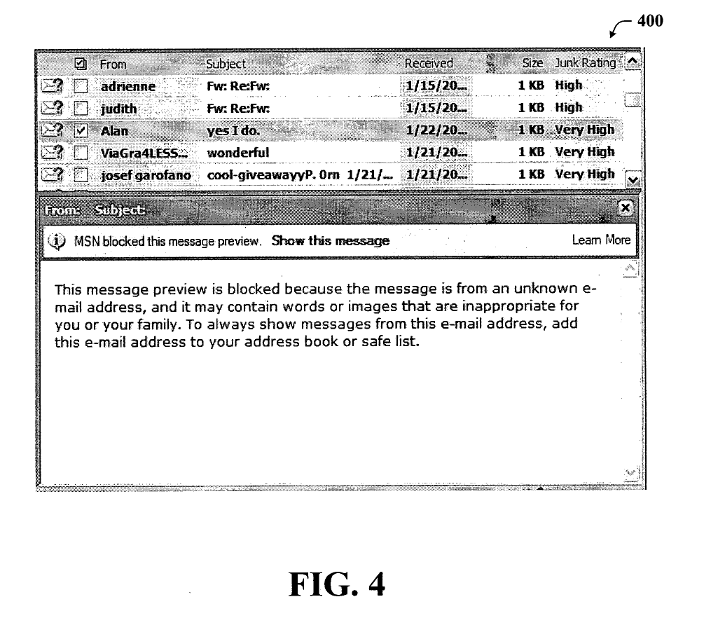

Referring now to FIG. 4, there is illustrated an exemplary user interface 400 that demonstrates a message which has been blocked from view in a preview pane in accordance with an aspect of the present invention. In particular, a text warning appears in place of the message content to notify the user or recipient that the message may include offensive content. The “From:” and/or “Subject:” lines may also be blocked in the message since spammers can include offensive content in either or both lines.

To view the blocked content, a user can explicitly click a button to unblock the display of the message preview. This prevents the user from accidentally displaying content on his screen that may be offensive to himself or to others in his household, for example. It should be appreciated that junk messages as classified by a filtering component can also be blocked in a similar manner.

Users can prevent future messages from particular senders from being blocked by simply adding such senders to one or more safe lists including an address book. Furthermore, the content blocking feature can be turned off to globally affect all messages regardless of their content and/or junk score.

Various methodologies in accordance with the subject invention will now be described via a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

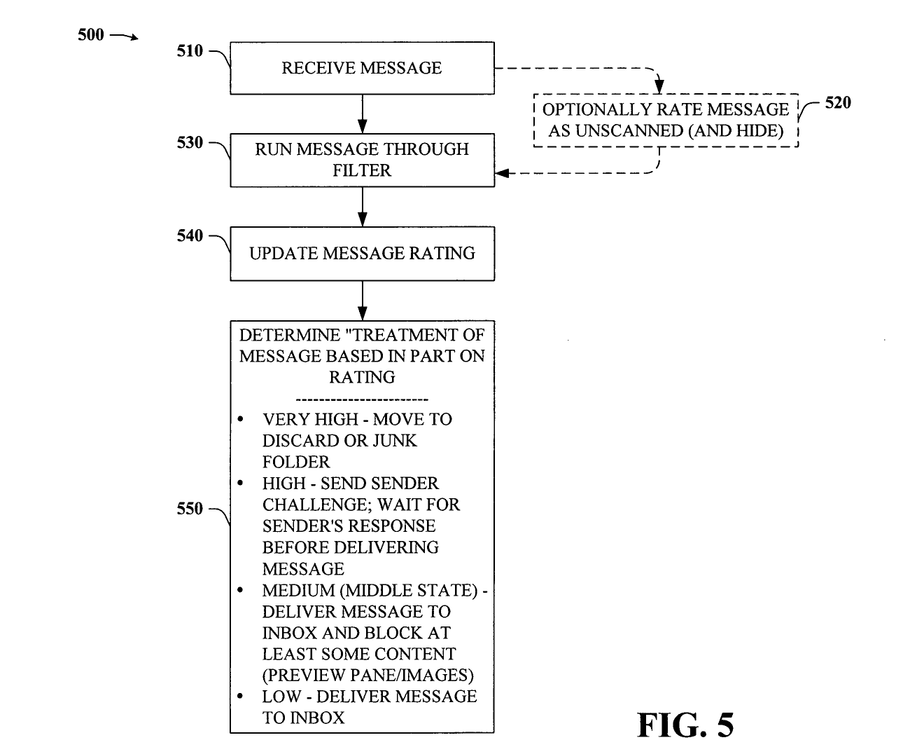

Referring now to FIG. 5, there is a flow diagram of a message filtration and treatment process 500 in accordance with an aspect of the present invention. The process 500 comprises receiving a message at 510. At 520, the message can optionally be rated as “unscanned” and be hidden from view until the message has been received in full. At that point, the message can be scanned by a filter at 530. Otherwise, the message can proceed directly to the filter at 530 without being assigned an unscanned rating.

At 540, the message rating can be updated to indicate its classification based in part on a junk score given to the message by the filter. At 550, the process can determine how to treat the message according to its rating and/or junk score. The rating can correspond to a junk score or junk score range which can be compared to a respective threshold for determining that the message is more likely to be junk, that the message or message sender is questionable, that the message may include objectionable content; and/or that the message or message sender is trusted.

For example, a very high junk rating can cause a message to be moved to a discard or junk folder without delivery to the inbox. A high junk rating can trigger a challenge to be sent to the sender of the message whereby a sender's correct response to the challenge may be required before allowing the message to be delivered to the recipient's inbox. A medium junk rating can allow a message to be delivered to the inbox; however the content of the message can be blocked or made unreadable in the preview pane. That is, the medium junk rating can be such that it exceeds a content blocking threshold. Thus, junk messages which have been accidentally delivered to the inbox can be blocked from view in the preview pane since their junk scores most likely exceed the content blocking threshold. Finally, low junk rated messages can be delivered to the inbox without any special treatment. Moreover, messages having junk scores that exceed the content-blocking threshold can have at least their body content removed from the preview pane.

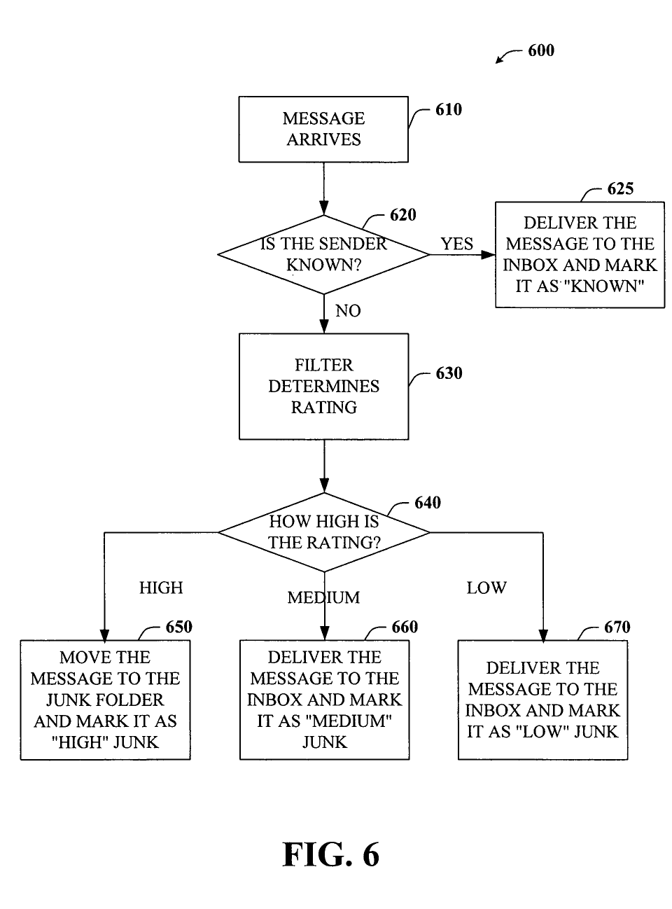

Turning to FIG. 6, there is illustrated a flow diagram of an exemplary method 600 that facilitates rating messages in accordance with an aspect of the present invention. The method 600 comprises a message arriving at a recipient's server at 610. At 620, the sender's identity can be determined. If the sender is known, then the message can be delivered to the inbox and marked as “known” at 625. However, if the message sender is not known at 620, then a junk filter can determine the message's junk rating at 630. At 640, treatment of the message can be based in part on how high the junk rating is for each respective message. For example, at 650, a high or very high message rating can cause the message to be sent to a junk folder where it may be marked with a “high” junk rating. High rated messages can also trigger a challenge to be sent to the message sender to obtain more information about the message or message sender.

At 660, a medium rating can cause a message to be sent to the inbox and marked with a medium junk rating. In addition, content of medium rated messages can be blocked from a preview pane to mitigate unintentional view of potentially offensive or objectionable content by the user or by others in view of the screen. Finally, a low rated message can be sent to the inbox without any other treatment and marked with a low junk rating.

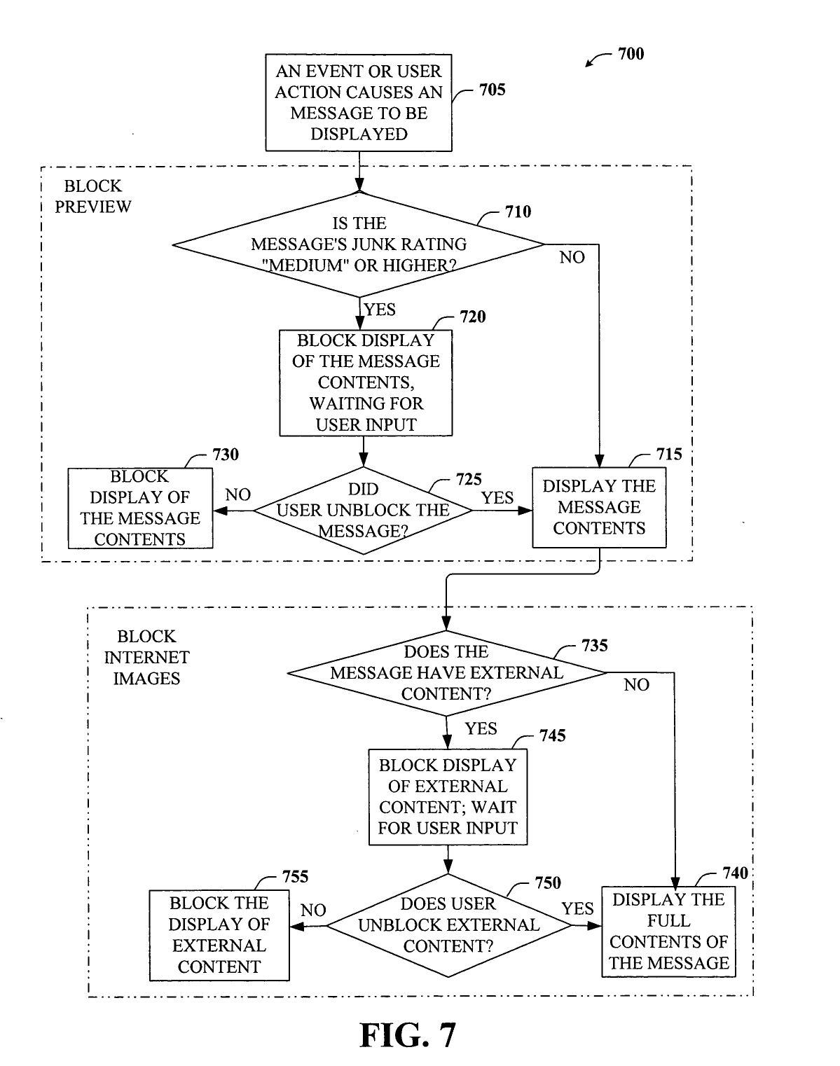

Referring now to FIG. 7, there is illustrated a flow diagram of an exemplary method 700 that facilitates blocking potentially offensive content including text and/or images from view in accordance with an aspect of the present invention. In particular, the method 700 involves an event or user action that causes a message to be displayed at 705. At 710, the process can determine whether the message's junk rating is above the content-blocking threshold. If the message junk rating is lower than this threshold, then message contents can be displayed at 715. However, if the message junk rating is at least medium, then the message contents can be blocked from display at 720 until additional user input is received.

If the user explicitly unblocks the message content at 725, then the message contents can be displayed at 715. Alternatively, the contents can remain blocked at 730 if no user input to unblock the message contents is received.

At 735, it can be determined whether the message includes any external images or references (to mitigate opening or launching of web beacons). If no, then the full contents of the message can be displayed in the preview pane at 740. If yes, then at 745 the display of external images or references can be blocked until user input to the contrary is received. If the user explicitly unblocks the external images or references at 750, then the full contents of the message can be displayed at 740. However, if no further user input is received to unblock the blocked images or references, then such images or references remain blocked at 755.

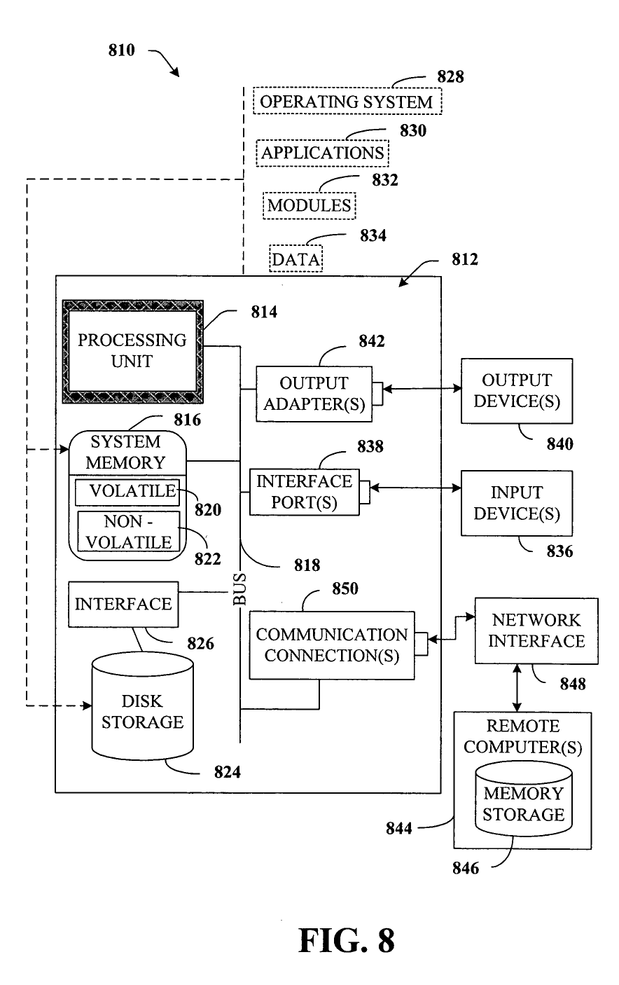

In order to provide additional context for various aspects of the present invention, FIG. 8 and the following discussion are intended to provide a brief, general description of a suitable operating environment 810 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 810 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/nonremovable, volatile/nonvolatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812 and to output information from computer 812 to an output device 840. Output adapter 842 is provided to illustrate that there are some output devices 840 like monitors, speakers, and printers among other output devices 840 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that mitigates viewing offensive message content comprising:
a message receiving component that receives at least one incoming message for delivery to a user;
a filtering component that calculates a junk score for the message; and
a content blocking component that blocks at least a portion of message content from appearing in at least a preview pane when the junk score exceeds a first threshold.

2. The system of claim 1, further comprising a classification component that classifies the message as any one of good, junk, and a middle state for messages determined to be safe for an inbox but not safe for viewing or previewing the message based in part on the junk score.

3. The system of claim 2, the message is classified at least in the middle state when the junk score exceeds at least the first threshold.

4. The system of claim 1, further comprising an analysis component that determines whether the junk score exceeds the first threshold.

5. The system of claim 1, further comprising an unblocking component that receives user input to unblock blocked message content.

6. The system of claim 5, the unblocking component operates per message.

7. The system of claim 1, the content blocking component operates per message or globally for substantially all messages.

8. The system of claim 1, the content comprises text, links, sounds, video, attachments, embedded content, applets, speech, and images.

9. The system of claim 1, the first threshold determined in part by user preferences.

10. The system of claim 1, the content blocking component blocks at least a portion of the message content by performing at least one of the following:
hiding at least a portion of the content of the message;
hiding at least a portion of a subject line of the message;
hiding content in a from line of the message;
blurring at least a portion of the subject line of the message;
blurring content in the from line of the message; and
blurring at least a portion of the content of the message.

11. The system of claim 1, the content blocking component replaces blocked content with at least one of text, graphics, video, and/or audio notice that warns users that potentially offensive content has been blocked from view.

12. The system of claim 1, flier comprising a challenge-response component that requests message senders to correctly respond to at least one challenge per message received when the junk score of that message exceeds a second threshold before delivery of the message is permitted.

13. The system of claim 12, the second threshold is any one of higher or lower than the first threshold.

14. The system of claim 12, the second threshold is about equal to the first threshold.

15. The system of claim 12, the second threshold is determined at least in part by user preferences.

16. The system of claim 12, the message associated with the challenged sender is hidden from view in a user's inbox until the challenge is correctly solved.

17. The system of claim 12, content of the message is blocked when the message is released to the user's inbox following a correctly solved challenge since the message's junk score exceeds the first threshold.

18. The system of claim 1, further comprising a rating component that rates incoming messages as unscanned before they are subjected to the filtering component.

19. The system of claim 18, unscanned messages are hidden from view and are not visible in a user's inbox while additional data about the message is collected or while the message is being filtered by the filtering component.

20. The system of claim 18, unscanned messages are made visible in a user's inbox when the filtering component is turned off.

21. A computer readable medium having stored thereon the system of claim 1.

22. A method that mitigates viewing offensive message content comprising:
receiving at least one incoming message;
computing a junk score for the at least one message; and
blocking at least a portion of message content from appearing in at least a preview pane when the junk score exceeds a blocking threshold.

23. The method of claim 22, further comprising classifying the message based in part on a computed junk score.

24. The method of claim 22, filer comprising classifying the message as unscanned before computing the junk score.

25. The method of claim 24, further comprising updating the message from unscanned to some other rating based in part on its computed junk score.

26. The method of claim 22, the content comprising at least one of text, images, sounds, audio, video, applets, embedded text, embedded images, URLs, and speech.

27. The method of claim 22, further comprising unblocking blocked content when explicit user input to unblock the content is received.

28. The method of claim 22, blocking the message content applies to substantially all messages globally when feature is activated.

29. The method of claim 22, further comprising requiring a password to open messages in which content has been blocked.

30. The method of claim 22, further comprising challenging a sender of the message before revealing any blocked content of the message.

31. The method of claim 22, further comprising challenging a sender of the message before allowing delivery of the message when the junk score of the message exceeds a challenge threshold.

32. The method of claim 31, the challenge threshold is any one of higher or lower than the blocking threshold.

33. The method of claim 31, the challenge threshold is about equal to the blocking threshold.

34. A system that mitigates viewing offensive message content comprising:
means for receiving at least one incoming message;
means for computing a junk score for the at least one message; and
means for blocking at least a portion of message content from appearing in at least a preview pane when the junk score exceeds a blocking threshold.

35. The system of claim 34, further comprising means for challenging a sender of the message before allowing delivery of the message when the junk score of the message exceeds a challenge threshold.

36. The system of claim 35, the challenge threshold is any one of higher or lower than the blocking threshold.

37. The system of claim 35, the challenge threshold is about equal to the blocking threshold.

38. The system of claim 34, further comprising means for unblocking blocked content when explicit user input to unblock the content is received.

39. The system of claim 34, further comprising means for classifying the message as unscanned before computing the junk score.

40. A data packet adapted to be transmitted between two or more computer processes that mitigates viewing offensive message content, the data packet comprising: information associated with receiving at least one incoming message; computing a junk score for the at least one message; and blocking at least a portion of message content from appearing in at least a preview pane when the junk score exceeds a blocking threshold.
